(19) United States
(12) Patent Application Publication
(10) Pub. No.: US 2025/0239111 A1
(43) Pub. Date: Jul. 24, 2025

(54) METHODS AND APPARATUS FOR PROVIDING AN ODOMETER FOR AN AUTONOMOUS VEHICLE

(71) Applicant: Nuro, Inc., Mountain View, CA (US)

(72) Inventors: Krishna Mohan, San Jose, CA (US); Zak Kasdan Dasaro, San Francisco, CA (US); Ruiqi Mao, Newark, CA (US)

(21) Appl. No.: 19/024,857

(22) Filed: Jan. 16, 2025

Related U.S. Application Data
(60) Provisional application No. 63/624,665, filed on Jan. 24, 2024.

(51) Int. Cl. G07C 5/02; G01C 22/00

(52) U.S. Cl. CPC G07C 5/02; G01C 22/00

(57) ABSTRACT

According to one aspect, a method includes obtaining sensor data from at least one encoder, the at least one sensor being positioned on a vehicle, wherein the vehicle includes an odometer arrangement and a memory, and processing the sensor data using the odometer arrangement. Processing the sensor data includes deriving odometer data from the sensor data, the odometer data being arranged to indicate a first distance travelled by the vehicle. The method also includes storing the odometer data in a memory of the vehicle, and providing the odometer data to an external storage.

### CROSS-REFERENCE TO RELATED APPLICATION

This patent application claims the benefit of priority under 35 U.S.C. § 119 of U.S. Provisional Patent Application No. 63/624,665, filed Jan. 24, 2024, and entitled “METHODS AND APPARATUS FOR PROVIDING AN ODOMETER FOR AN AUTONOMOUS VEHICLE,” which is hereby incorporated by reference in its entirety.

### TECHNICAL FIELD

The disclosure relates to providing systems for autonomous vehicles. More particularly, the disclosure relates to an odometer system which provides redundancy.

### BACKGROUND

The ability to track the distances driven by a vehicle is critical to enable accurate assessments to be made as to the lifetime of components and systems of the vehicle. For example, the lifetime of components such as tires on a vehicle are often defined based upon distances driven. When the distances driven by a vehicle are not tracked in an accurate manner, it may be difficult to accurately determine when components or systems may need maintenance and/or replacement. As a result, the safety with which the vehicle operates may be compromised.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4 is a block diagram representation of an odometer arrangement, e.g., odometer arrangement 342 of FIG. 3, in accordance with an embodiment.

FIG. 5 is a diagrammatic representation of a process of obtaining encoder data and storing odometer data in accordance with an embodiment.

FIG. 6 is a process flow diagram which illustrates a method of generating and storing odometer data in accordance with an embodiment.

FIG. 7 is a process flow diagram which illustrates a method of obtaining odometer data in accordance with an embodiment.

FIG. 8 is a process flow diagram which illustrates a method of resolving a mismatch between a vehicle and an odometer arrangement in accordance with an embodiment.

FIG. 9 is a process flow diagram which illustrates a method of storing that odometer data that includes storing odometer data in random access memory (RAM) and flash memory in accordance with an embodiment.

FIG. 10 is a process flow diagram which illustrates a method of generating odometer data, e.g., step 909 of FIG. 9, in accordance with an embodiment.

FIG. 11 is a process flow diagram which illustrates a method of obtaining stored odometer data in accordance with an embodiment.

FIG. 12 is a diagrammatic representation of a process of obtaining encoder data and storing odometer data that includes utilizing data from a secondary source in accordance with an embodiment.

### DESCRIPTION OF EXAMPLE EMBODIMENTS

### General Overview

In accordance with one aspect, a method includes obtaining sensor data from at least one sensor, the at least one sensor being positioned on a vehicle, wherein the vehicle includes an odometer arrangement and a memory, and processing the sensor data using the odometer arrangement. Processing the sensor data includes deriving odometer data from the sensor data, the odometer data being arranged to indicate a first distance travelled by the vehicle. The method also includes storing the odometer data in a memory of the vehicle, and providing the odometer data to an external storage. The sensor may be an encoder, in one embodiment.

According to another aspect, logic is encoded in one or more tangible non-transitory, computer-readable media for execution. When executed, the logic is operable to obtain encoder data from at least one encoder, the at least one encoder being positioned on a vehicle, wherein the vehicle includes an odometer arrangement and a memory, and to process the encoder data using the odometer arrangement, wherein the logic operable to process the encoder data is operable to derive odometer data from the encoder data, the odometer data being arranged to indicate a first distance travelled by the vehicle. The logic is also operable to store the odometer data in a memory of the vehicle, and to provide the odometer data to an external storage.

According to still another aspect a vehicle includes a chassis, a memory carried on the chassis, at least one wheel coupled to the chassis, one or more tangible non-transitory, computer-readable media carried on the chassis, and logic encoded in the one or more tangible non-transitory, computer-readable media for execution. The at least one wheel has at least one encoder positioned thereon. When executed, the logic is operable to obtain encoder data from the at least one encoder, process the encoder data, wherein the logic operable to process the encoder data is operable to derive odometer data from the encoder data, the odometer data being arranged to indicate a first distance travelled by the vehicle, store the odometer data in the memory, and provide the odometer data to an external storage.

In one embodiment, an odometer arrangement of an autonomous vehicle includes a primary odometer and a backup odometer which utilize data from an encoder arrangement on a tire to determine a total distance travelled by the vehicle. The odometer data may be stored in flash memory onboard the vehicle, and periodically uploaded to a data storage arrangement that is not onboard the vehicle, e.g., uploaded onto a cloud server and stored with a vehicle identification number (VIN) of the vehicle. When odometer data is needed, the odometer data is obtained from the primary odometer when possible. When the primary odometer may not be used to obtain the odometer data, the odometer data may be obtained from the backup odometer. In the event that the odometer data may not be obtained from either the primary odometer or the backup odometer, the odometer data may be obtained from the data storage arrangement. To substantially prevent the odometer data from being tampered with, security measures such as blockchain may be implemented with respect to the data storage arrangement.

### DESCRIPTION

The total distance travelled by a vehicle during its lifetime is generally tracked by an odometer onboard the vehicle. The ability to accurately determine or track the distance travelled by a vehicle during a lifetime of the vehicle is generally an important metric that is used to assess the condition of the vehicle. For instance, the total distance travelled by the vehicle, or vehicle mileage, may be used to determine when maintenance on the vehicle is to be performed, e.g., to determine when certain parts on the vehicle are scheduled for maintenance and/or replacement. When the distance travelled by a vehicle is not accurately tracked, the performance of maintenance on the vehicle in a timely fashion may be compromised. As such, the ability to accurately determine the distance travelled by a vehicle is critical.

A vehicle, as for example an autonomous vehicle, may include a software-defined odometer arrangement which uses data from an encoder, as for example an optical encoder, that measures rotations of a wheel or a tire of the vehicle to determine a distance travelled by the vehicle. The odometer arrangement may track a total distance driven or travelled by the vehicle over a lifetime of the vehicle. To ensure that odometer data is available, the odometer arrangement may include a primary odometer and a secondary, or backup, odometer which each store the odometer data. The odometer data, or vehicle mileage, may also be stored off of the vehicle, e.g., in a data storage arrangement or a cloud server, and may be accessed by the odometer arrangement. The odometer data stored in a data storage arrangement or on a cloud server may be securely stored to reduce the likelihood of the odometer data being tampered with. When neither the primary nor backup odometers may be used to retrieve odometer data, the odometer data may be retrieved from the data storage arrangement or cloud server.

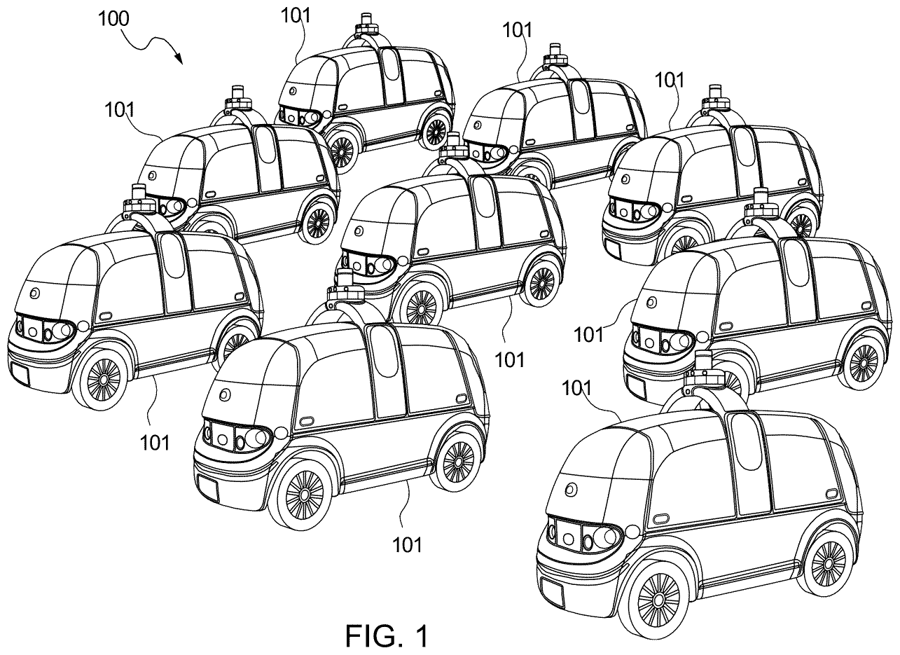

A vehicle that includes a software-defined odometer arrangement may be an autonomous vehicle that is part of an autonomous vehicle fleet. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. It should be appreciated, however, that autonomous vehicles 101 are not limited to transporting and/or delivering goods. For instance, some autonomous vehicles 101 in fleet 100 may be suitable to transport occupants or passengers, either in addition to or in lieu of goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown) that may dispatch autonomous vehicles 101 for purposes of transporting, delivering, and/or retrieving goods or services in an unstructured open environment or a closed environment. It should be appreciated that in some embodiments, a fleet management module (not shown) may additionally, or alternatively, dispatch autonomous vehicles 101 for purposes of transporting occupants.

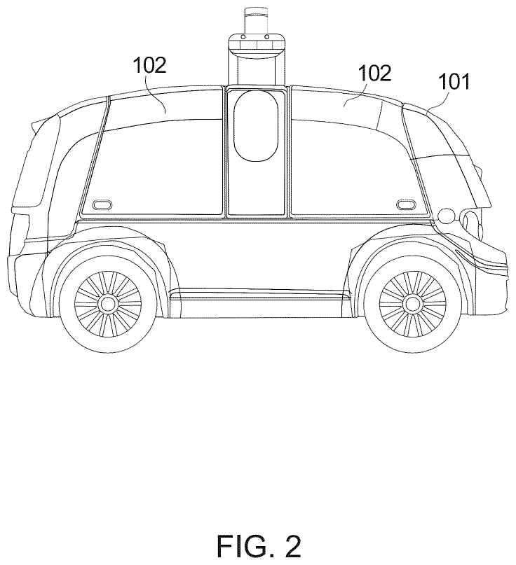

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

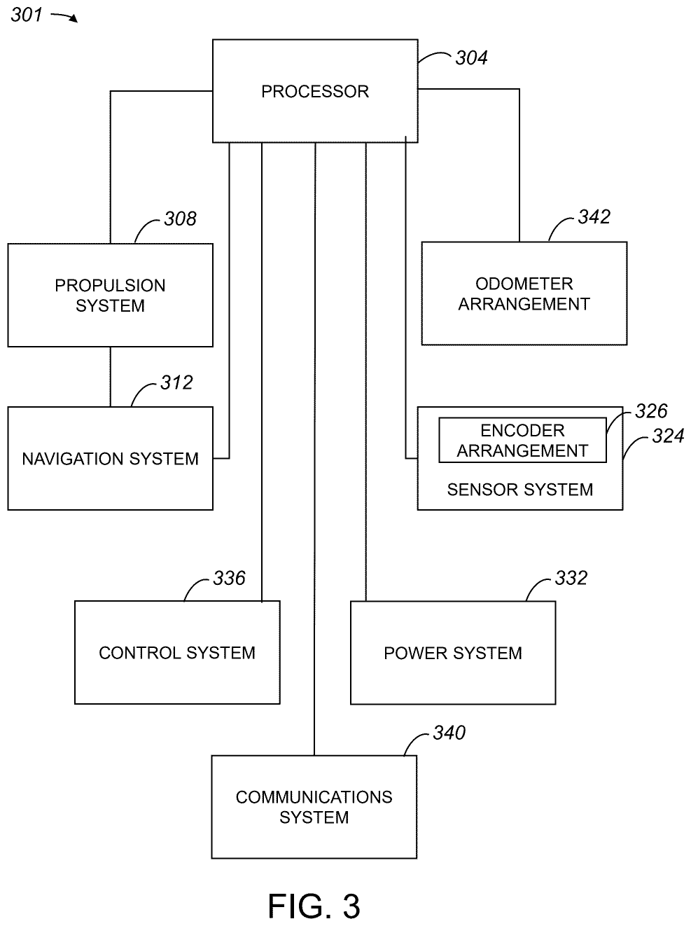

With reference to FIG. 3, the components of an autonomous vehicle will be described in accordance with an embodiment. FIG. 3 is a block diagram representation of an autonomous vehicle in accordance with an embodiment. An autonomous vehicle 301 includes a processor 304, a propulsion system 308, a navigation system 312, a sensor system 324, a power system 332, a control system 336, a communications system 340, and an odometer arrangement 342. Processor 304, propulsion system 308, navigation system 312, sensor system 324, power system 332, communications system 340, and odometer arrangement 342 are all generally coupled to a chassis or body of autonomous vehicle 301. Autonomous vehicle 101 of FIGS. 1 and 2 may generally be embodied as autonomous vehicle 301, e.g., autonomous vehicle 101 may include the components of autonomous vehicle 301. It should be appreciated that while autonomous vehicle 301 may be configured as a delivery vehicle with one or more compartments suitable for carrying cargo or goods, autonomous vehicle 301 is not limited to being a delivery vehicle and may, for example, transport occupants or passengers.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 301 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 301 through paths and/or within unstructured open or closed environments. Navigation system 312 may include at least one of digital maps, street view photographs, and a global positioning system (GPS) point. Maps, for example, May be utilized in cooperation with sensors included in sensor system 324 to allow navigation system 312 to cause autonomous vehicle 301 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 301 to safely navigate, and to ascertain when there are objects near autonomous vehicle 301. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 301. In one embodiment, sensor system 324 includes an encoder arrangement 326 which includes at least one encoder that is mounted on, or otherwise positioned on, a wheel, motor, and/or drive shaft of vehicle 301. The one or more encoders included in encoder arrangement 326 may provide data that may be used, as for example by odometer arrangement 342, to substantially determine a speed and a distance travelled by vehicle 301 by measuring a rotation of a wheel, motor, and/or drive shaft of autonomous vehicle 301. For example, at least one encoder may provide information relating to how many rotations of a wheel, motor, and/or drive shaft may have occurred during a given time increment or interval.

Power system 332 is arranged to provide power to autonomous vehicle 301. Power may be provided as electrical power, gas power, or any other suitable power, e.g., solar power or battery power. In one embodiment, power system 332 may include a main power source, and an auxiliary power source that may serve to power various components of autonomous vehicle 301 and/or to generally provide power to autonomous vehicle 301 when the main power source does not have the capacity to provide sufficient power.

Communications system 340 allows autonomous vehicle 301 to communicate, as for example, wirelessly, with a fleet management system (not shown) that allows autonomous vehicle 301 to be controlled remotely. Communications system 340 generally obtains or receives data, stores the data, and transmits or provides the data to a fleet management system and/or to autonomous vehicles 301 within a fleet. The data may include, but is not limited to including, information relating to scheduled requests or orders, information relating to on-demand requests or orders, and/or information relating to a need for autonomous vehicle 301 to reposition itself, e.g., in response to an anticipated demand. Communications system 340 may also support communications between odometer arrangement 342 and a data storage arrangement (not shown) which may be remote with respect to vehicle autonomous 301.

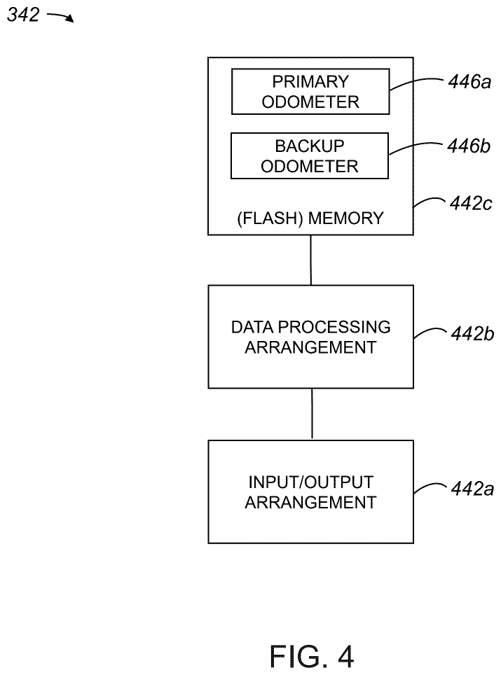

Odometer arrangement 342, which will be discussed below with respect to FIG. 4, is arranged to process data provided by encoder arrangement 326 to determine a distance travelled by autonomous vehicle 301 and to store information relating to the distance as odometer data, as for example vehicle mileage. Odometer arrangement 342 is generally configured to store odometer data in odometer arrangement 342, and to cooperate with communications system 340 to store the odometer data remotely, as for example on a cloud server or a cloud storage. Odometer arrangement 342 is also arranged to cause odometer data to be provided to other systems within autonomous vehicle 301, e.g., for display on a human machine interface (HMI), as well as to other systems, e.g., a device in the possession of a fleet or maintenance technician. It should be appreciated that odometer arrangement 342 may generally be a module that includes hardware and/or software logic or code devices that are executable by a processor.

In some embodiments, control system 336 may cooperate with processor 304 to determine where autonomous vehicle 301 may safely travel, and to determine the presence of objects in a vicinity around autonomous vehicle 301 based on data, e.g., results, from sensor system 324. In other words, control system 336 may cooperate with processor 304 to effectively determine what autonomous vehicle 301 may do within its immediate surroundings. Control system 336 in cooperation with processor 304 may essentially control power system 332 and navigation system 312 as part of driving or conveying autonomous vehicle 301. Additionally, control system 336 may cooperate with processor 304 and communications system 340 to provide data to or obtain data from other autonomous vehicles, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow autonomous vehicle 301 to operate autonomously. That is, autonomous vehicle 301 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 301 to facilitate autonomous or semi-autonomous driving.

As will be appreciated by those skilled in the art, when autonomous vehicle 301 operates autonomously, autonomous vehicle 301 may generally operate, e.g., drive, under the control of an autonomy system. That is, when autonomous vehicle 301 is in an autonomous mode, autonomous vehicle 301 is able to generally operate without a driver or a remote operator controlling autonomous vehicle. In one embodiment, autonomous vehicle 301 may operate in a semi-autonomous mode or a fully autonomous mode. When autonomous vehicle 301 operates in a semi-autonomous mode, autonomous vehicle 301 may operate autonomously at times and may operate under the control of a driver or a remote operator at other times. When autonomous vehicle 301 operates in a fully autonomous mode, autonomous vehicle 301 typically operates substantially only under the control of an autonomy system. The ability of an autonomous system to collect information and extract relevant knowledge from the environment provides autonomous vehicle 301 with perception capabilities. For example, data or information obtained from sensor system 324 may be processed such that the environment around autonomous vehicle 301 may effectively be perceived. Using information relating to the perceived environment, planner capabilities may be used to identify a suitable route to be travelled by autonomous vehicle 301 when autonomous vehicle 301 operates under the control of an autonomy system.

Odometer arrangement 342, as discussed above, is generally arranged to process data collected or captured by sensor system 324, e.g., by encoder arrangement 326, to obtain odometer data for autonomous vehicle 301. Odometer data typically includes a total distance travelled by autonomous vehicle 301 over the lifetime of autonomous vehicle 301. With reference to FIG. 4, odometer arrangement 342 will be described in accordance with an embodiment. Odometer arrangement 342 includes an input/output arrangement 442a, a data processing arrangement 442b, and a memory 442c that effectively includes a primary odometer 446a and a secondary or backup odometer 446b. In one embodiment, odometer arrangement 342 may be part of a main compute module of a vehicle, although odometer arrangement 342 is not limited to being part of a main compute module of a vehicle.

Input/output arrangement 442a is generally arranged to enable odometer arrangement 342 to communicate with other systems on a vehicle, e.g., vehicle 101 of FIGS. 2 and 3. Input/output arrangement may include at least one port which enables data to be transferred to and from odometer arrangement 342. Such a port may be arranged to support network communications as well. For example, input/output arrangement 442a may be arranged to enable odometer arrangement 342 to communicate with an external data storage arrangement or data repository.

Data processing arrangement 442b is arranged to process data or information obtained by input/output arrangement 442a. Input/output arrangement 442 may obtain encoder data from an encoder arrangement such as encoder arrangement 326 of FIG. 3, and process the encoder data to determine a distance travelled that is indicated by the encoder data. For example, when encoder data is indicative of a number of turns of a wheel of a vehicle such as vehicle 101 of FIGS. 1 and 2, or vehicle 301 of FIG. 3, over a particular time period, data processing arrangement 442b may calculate or otherwise determine the distance travelled by the vehicle over the particular time period using the encoder data and other information including, but not limited to including, a circumference or radius of the wheel. Data processing arrangement 442b may generally apply a formula or an algorithm to effectively transform encoder data into odometer data.

Memory 442c, which may be a flash memory, is arranged to substantially implement primary odometer 446a and backup odometer 446b. Primary odometer 446a and backup odometer 446b each store odometer data that is determined by data processing arrangement 442b.

In one embodiment, the odometer data stored in primary odometer 446a and backup odometer 446b may be cumulative. That is, the distance travelled recently by a vehicle such as vehicle 101 of FIGS. 2 and 3, as determined by data processing arrangement 442b, may be added to the overall distance previously travelled by the vehicle in order to substantially obtain a total distance travelled over a lifetime of the vehicle. It should be appreciated, however, that the distance travelled recently may be stored in primary odometer 446a and backup odometer 446b substantially as-is, When the distance travelled recently is stored substantially as-is, the distance travelled recently may be added to other stored distances travelled when a total distance travelled is requested.

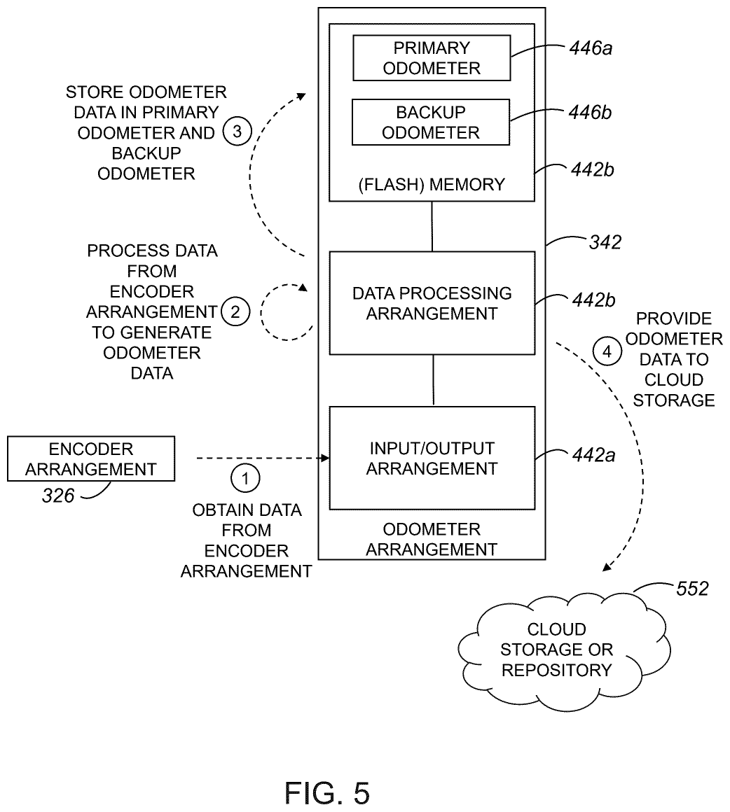

Referring next to FIG. 5, a process of obtaining encoder data and storing odometer data will be discussed in accordance with an embodiment. Encoder arrangement 326 and odometer arrangement 342 are included in vehicle 301 of FIG. 3. At a time t1, input/output arrangement 442a obtains data from encoder arrangement 326. The data may generally be raw data obtained from encoder arrangement 342 that relates to a number of times a wheel of vehicle 101 of FIG. 2 or vehicle 301 of FIG. 3 has turned during a particular time period.

The data or information obtained from encoder arrangement 326 is processed by data processing arrangement 442b to generate odometer data at a time t2. The odometer data is stored in primary odometer 446a and backup odometer 446b of memory 442c at a time t3.

At a time t4, data processing arrangement 442b causes odometer data to be stored in an external storage arrangement 552, e.g., a cloud storage or repository. Data processing arrangement 442b may communicate with external storage arrangement 552 using input/output arrangement 442a. It should be appreciated that communications between input/output arrangement 442a and external storage arrangement 552 may utilize communications system 340 of FIG. 3 to support communications involving input/output arrangement 442a.

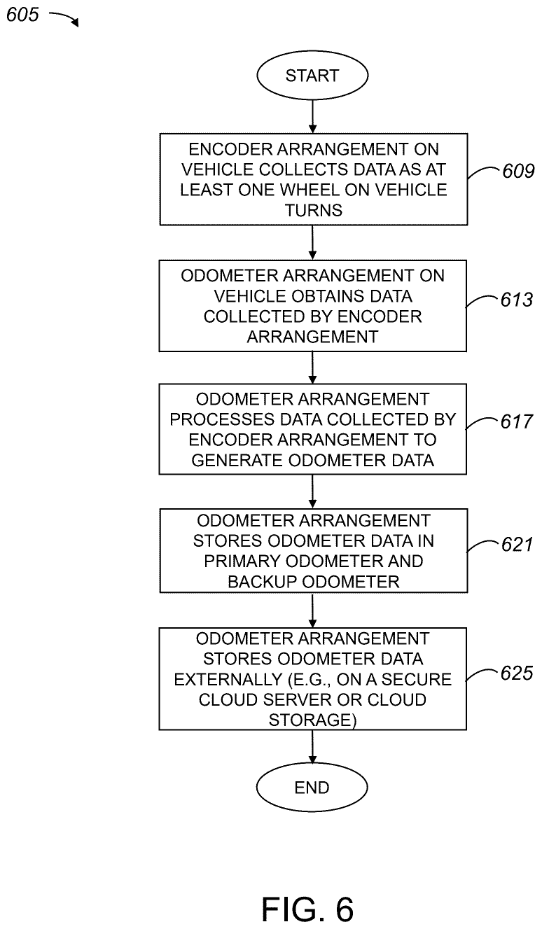

FIG. 6 is a process flow diagram which illustrates a method of generating and storing odometer data in accordance with an embodiment. A method 605 of generating and storing odometer data begins at a step 609 in which an encoder arrangement on a vehicle collects data as at least one wheel on the vehicle turns or rotates.

In a step 613, an odometer arrangement on the vehicle obtains the data collected by the encoder arrangement. It should be appreciated that the odometer arrangement may periodically obtain the data collected by the encoder arrangement, or may obtain the data collected by the encoder arrangement substantially continuously.

After the odometer arrangement obtains encoder data or data collected by the encoder arrangement, the odometer arrangement processes the encoder data in a step 617. The odometer arrangement processes the encoder data to generate odometer data. Once the odometer data is generated, process flow proceeds to a step 621 in which the odometer arrangement stores the odometer data in the primary odometer and the backup odometer. It should be understood that substantially the same odometer data is stored in the primary odometer and the backup odometer.

The odometer arrangement stores the odometer data externally in a step 625. Storing the odometer data externally may involve storing the odometer data on a cloud server, e.g., a secure cloud server, or in cloud storage. The odometer data may be stored externally in a secure manner to substantially protect the accuracy of the odometer data, e.g., to prevent tampering with the odometer data. In one embodiment, the odometer data may be stored securely in a blockchain in a network such as a cloud network. Typically, the odometer data is stored externally on a periodic basis. In other words, the odometer arrangement may store the odometer data at predetermined times or when particular events occur. For example, the odometer arrangement may store the odometer data at a particular time each day or each time a vehicle is powered down. Upon storing the odometer data externally, the method of generating and storing odometer data is completed.

Odometer data for a vehicle may be requested by systems on the vehicle and/or by systems external to the vehicle. For example, a maintenance or fleet technician may request odometer data to determine whether a total distance driven by the vehicle over a lifetime or over a predetermine time period indicates that scheduled maintenance on the vehicle is warranted. Requests for odometer data may result in the odometer data being provided by either a primary odometer or backup odometer or, when the primary odometer and backup odometer are not accessible, an external storage arrangement.

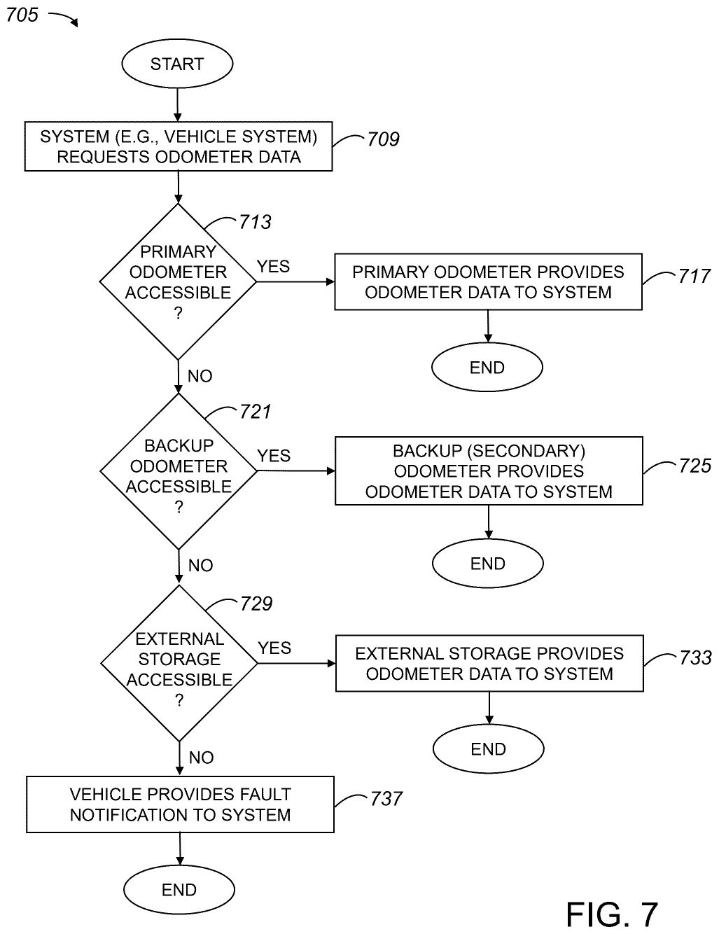

FIG. 7 is a process flow diagram which illustrates a method of obtaining odometer data from a vehicle in accordance with an embodiment. A method 705 of obtaining odometer data from a vehicle begins at a step 709 in which a system requests odometer data. The system which requests the odometer data may be a system included in the vehicle, or the system may be a system external to the vehicle.

Once the system requests odometer data, a determination is made in a step 713 as to whether a primary odometer of an odometer arrangement on the vehicle is accessible, or able to provide odometer data. In other words, it is determined whether odometer data may be accessed through the primary odometer of an odometer arrangement.

If it is determined in step 713 that the primary odometer is accessible, the implication is that odometer data stored on the primary odometer may be retrieved. As such, in a step 717, the primary odometer provides odometer data to the system, and the method of obtaining odometer data from a vehicle is completed. It should be appreciated that the primary odometer may provide odometer data through a network connection to either another system of the vehicle or to a system external to the vehicle.

Alternatively, if it is determined in step 713 that the primary odometer is not accessible, the implication may be that the primary odometer is not accessible due to a connection failure, a hardware failure, and/or data corruption issues. Accordingly, a determination is made in a step 721 as to whether a backup or secondary odometer of the odometer arrangement is accessible. If it is determined that the backup odometer is accessible, then in a step 725, the backup odometer provides odometer data to the system, and the method of obtaining odometer data from a vehicle is completed.

Returning to step 721, if it is determined that the backup odometer is not accessible, then process flow moves to a step 729 in which it is determined whether odometer data stored on an external storage arrangement is accessible. In other words, it is determined whether odometer data effectively backed up on a source external to a vehicle may be accessed to obtain, e.g., to retrieve, odometer data.

If the determination in step 729 is that an external storage arrangement is accessible, the indication is that odometer data stored on an external storage arrangement may be retrieved. As such, process flow moves from step 729 to a step 733 in which the external storage arrangement provides odometer data to the system, and the method of obtaining odometer data from a vehicle is completed.

Alternatively, if it is determined in step 729 that the external storage arrangement is not accessible, the vehicle provides a fault notification to the system in a step 737. The fault notification may generally be an indication that odometer data is not accessible to the system. Providing the fault notification may include, but is not limited to including, effectively sending a predetermined signal or message to the system, displaying a predetermined message on a display screen associated with the vehicle or the system, and/or providing a message to a fleet technician. Upon the vehicle providing a fault notification to the system, the method of obtaining odometer data from a vehicle is completed.

In one embodiment, an odometer arrangement is a component on a controller board that may be included in a vehicle. For example, an odometer arrangement may be part of a brain stem controller (BSC) board which provides controllers and functionality for a vehicle. A BSC board may include, but is not limited to including, at least processor 304, control system 336, and odometer arrangement 342 of FIG. 3. The BSC board may be separate from an overall main compute system of a vehicle, or may be included as part of an overall main compute system such that the BSC board communicates regularly with the overall main compute system. The BSC board may generally include hardware and/or software logic embodied on one or more tangible non-transitory, computer-readable media. In some situations, when a controller board such as a BSC board with an odometer arrangement is removed from a first vehicle and placed in a second vehicle, the odometer data stored on the odometer arrangement may not be accurate with respect to the second vehicle. That is, there may be a mismatch between a VIN associated with the odometer data stored on a controller board and a VIN of the vehicle in which the controller board is placed. For example, when a controller board with an odometer arrangement is removed from a first vehicle for repair, the repaired controller board may be assigned to a second vehicle in the event that a new controller board has already been provided to the first vehicle.

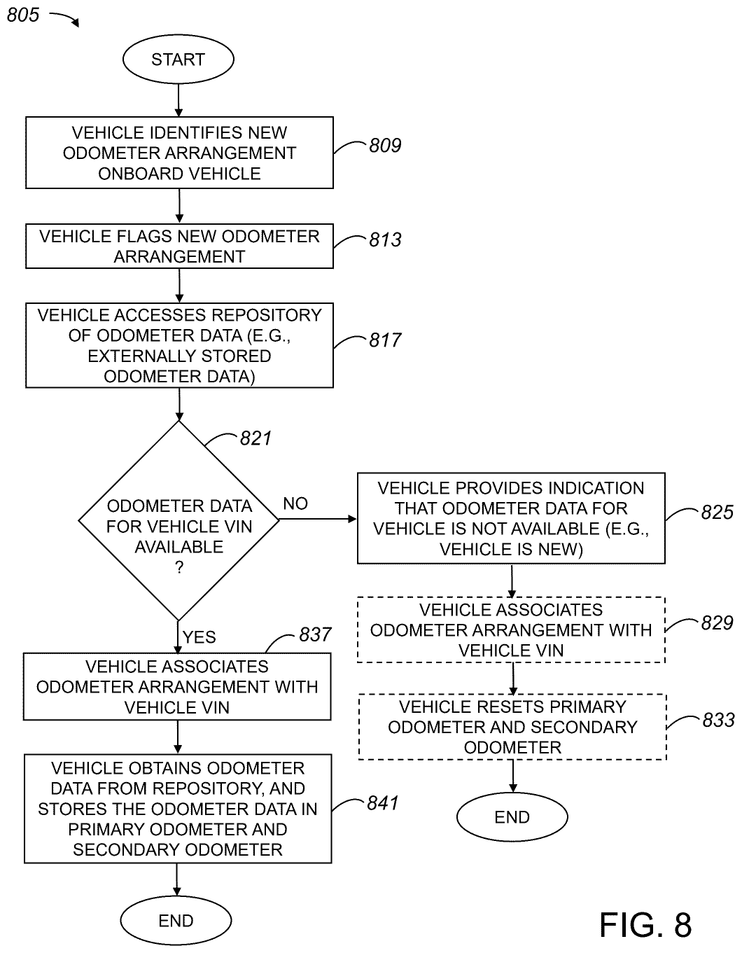

FIG. 8 is a process flow diagram which illustrates a method of resolving a mismatch between a vehicle and an odometer arrangement in accordance with an embodiment. A method 805 of resolving a mismatch between a vehicle and an odometer arrangement situated on a controller board begins at a step 809 in which the vehicle identifies a new odometer arrangement onboard the vehicle. A new odometer arrangement may be identified when the odometer arrangement includes primary and backup odometers that do not have any associated odometer data. It should be appreciated that a new odometer arrangement may be an odometer arrangement which was previously used onboard a different vehicle, but is newly associated with the current vehicle in which the odometer arrangement is installed or incorporated.

In a step 813, the vehicle flags the new odometer arrangement. That is, the vehicle provides an indication that the odometer arrangement installed in the vehicle is new with respect to the vehicle. Such an indication may be propagated to various systems within the vehicle, and/or may be provided to an external system.

After flagging the new odometer arrangement, the vehicle accesses a repository of odometer data in a step 817. For example, the vehicle accesses externally stored odometer data such as odometer data stored in a cloud repository.

Once the vehicle accesses the repository of odometer data, a determination is made in a step 821 as to whether the repository of odometer data contains odometer data for the vehicle. The odometer data for the vehicle may generally be stored with a VIN for the vehicle such that the odometer data may be associated with the vehicle.

If it is determined in step 821 that there is no odometer data in the repository of odometer data that corresponds with the VIN for the vehicle, the indication is that the vehicle is new or that the vehicle has otherwise not been driven in the past. As such, process flow moves from step 821 to a step 825 in which the vehicle provides an indication that odometer data for the vehicle is not available. The indication that odometer data for the vehicle is not available may be provided to an enterprise. Such an indication may effectively identify the vehicle as new.

Once the vehicle provides an indication that odometer data for the vehicle is not available, process flow proceeds to an optional step 829 in which the vehicle associates the odometer arrangement with the vehicle VIN. Associating the odometer arrangement with the vehicle VIN may enable the odometer arrangement to be readily identified as a component on the vehicle, and may enable odometer data stored in a repository of odometer data to be identified as being associated with the vehicle.

In an optional step 833, the vehicle resets the primary odometer and the secondary odometer of the odometer arrangement. Resetting the primary odometer and the secondary odometer may involve setting each odometer to indicate that no distance has been driven by the vehicle. Upon optionally resetting the primary and secondary odometer, or after providing an indication that odometer data for the vehicle is not available, the method of resolving a mismatch between a vehicle and an odometer arrangement situated on a controller board is completed.

Returning to step 821 and the determination of whether odometer data for the vehicle is available in a repository of odometer data, if it is determined that odometer data for the vehicle is available in the repository of odometer data, the vehicle associates the odometer arrangement with the vehicle VIN in a step 837. In one embodiment, associating the odometer arrangement with the vehicle VIN may include storing the vehicle VIN in the odometer arrangement, as for example in flash memory included in the odometer arrangement.

After the vehicle associates the odometer arrangement with the vehicle VIN, the vehicle obtains odometer data from the repository of odometer data in a step 841, and stores the odometer data in the primary odometer and the secondary odometer of the odometer arrangement. It should be appreciated that the odometer data obtained from the repository is odometer data associated with the vehicle VIN. Once the vehicle stores the odometer data in the primary odometer and the secondary odometer, the method of resolving a mismatch between a vehicle and an odometer arrangement situated on a controller board is completed.

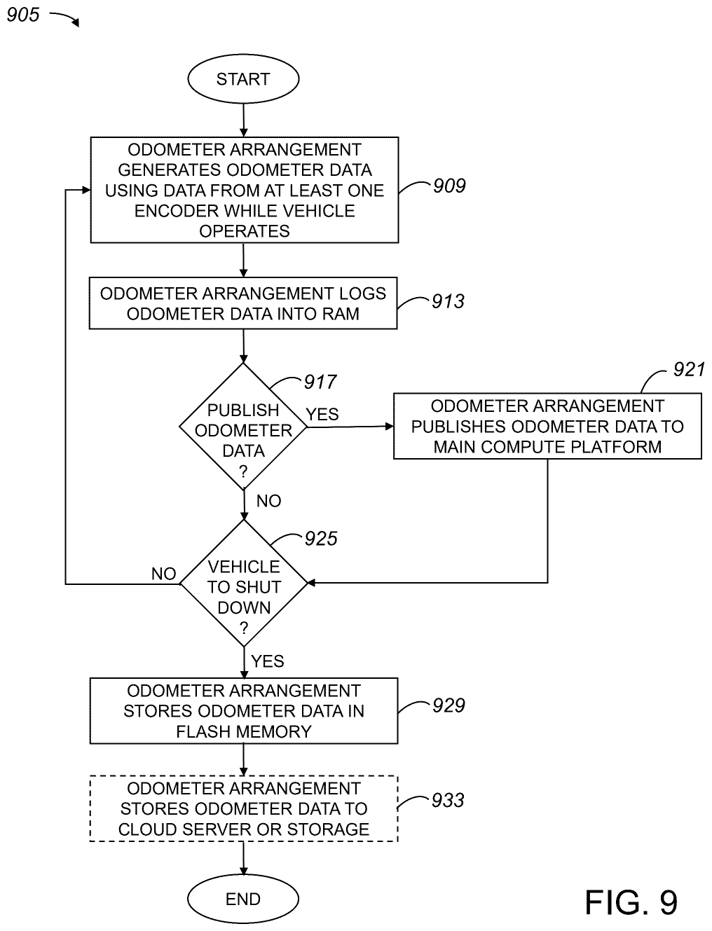

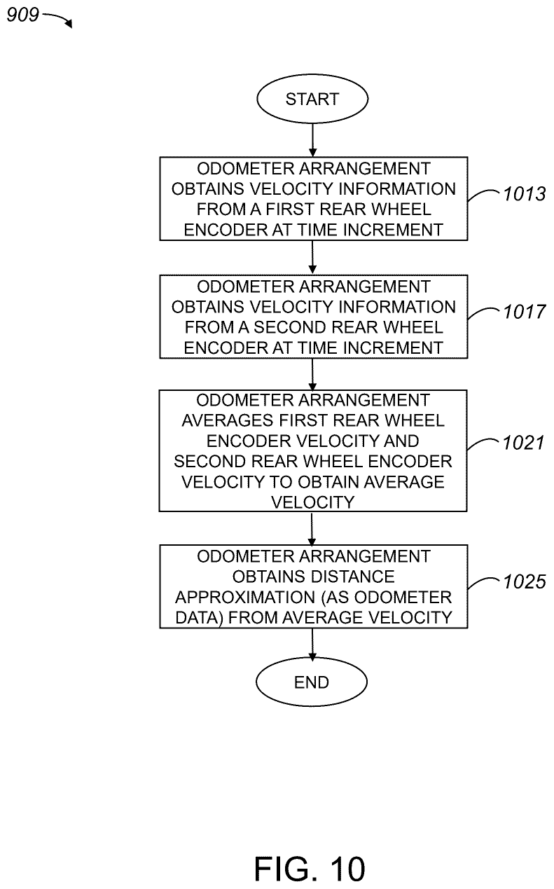

While storing odometer data in a flash memory such as memory 442c of FIG. 4 is effective in providing an ability for odometer data to be obtained efficiently, flash memory may exhibit wear as a result of repeated flash memory erase cycles. As such, reducing the number of times the flash memory is erased may enable the integrity of the flash memory to be preserved for a longer period of time. For example, odometer data may be stored or written to a flash memory substantially only when a vehicle shuts down or is about to shut down in order to reduce the number of times the flash memory is erased. While the vehicle is operating, odometer data may be stored, e.g., stored periodically, in random access memory (RAM). With reference to FIG. 9, a method of storing odometer data that reduces wear on flash memory will be described in accordance with an embodiment. A method 905 of storing odometer data begins at a step 909 in which an odometer arrangement generates odometer data using data from at least one encoder mounted on a vehicle while the vehicle operates, e.g., drives. The steps associated with one method of generating odometer data will be discussed below with respect to FIG. 10.

Once the odometer arrangement generates odometer data, as for example substantially continuously while the vehicle operates or is otherwise powered on, the odometer arrangement may log or otherwise store the odometer data into RAM in a step 913. The RAM may be part of the odometer arrangement, or the RAM may be substantially separate from the odometer arrangement but accessible to the odometer arrangement.

In a step 917, a determination is made as to whether the odometer data is to be published. By publishing odometer data, specific readings of historical odometer data may be substantially matched up with logging messages associated with logs obtained from a main compute of the vehicle. A determination of whether odometer data is to be published may generally include determining whether the odometer data is to be made accessible, e.g., whether a time interval at which the odometer data is to be accessed has passed. Such a determination may effectively be triggered periodically, as for example approximately every five milliseconds. It should be appreciated that the odometer data or value may be published along with other vehicle status data.

If it is determined that odometer data is not to be published, a determination is made in a step 925 as to whether the vehicle is to shut down. If the determination is that the vehicle is not to shut down, the implication is that the vehicle is to continue operating and that the odometer arrangement is to continue to generate odometer data. As such, process flow returns from step 925 to step 909 in which the odometer arrangement continues to generate odometer data.

Alternatively, if it is determined in step 925 that the vehicle is to shut down, e.g., at the end of a mission, the odometer arrangement stores the odometer data in a step 929 in a flash memory. By storing odometer data in flash memory when the vehicle is to shut down, the odometer data may effectively be preserved for access the next time the vehicle powers on, while generally reducing the number of times odometer data is written or stored in flash memory.

From step 929, process flow proceeds to an optional step 933 in which the odometer arrangement stores the odometer data to a cloud server or storage. It should be appreciated that in addition to storing odometer data to a cloud server or storage, logs from a main compute may also be uploaded to a cloud server or storage. After the odometer data is stored in flash memory, and optionally stored on a cloud server or storage, the method of storing odometer data is completed.

Returning to step 917 and the determination of whether odometer data is to be published, if it is determined that the odometer data is to be published, the odometer arrangement publishes the odometer data in a step 921 to a main compute platform on the vehicle. Publishing the odometer data enables the odometer data to essentially be accessed by accessing the main compute platform, or an overall platform which enables the vehicle to operate autonomously.

With reference to FIG. 10, a method of generating odometer data from at least one encoder on a vehicle, e.g., step 909 of FIG. 9, in accordance with an embodiment. A method or step 909 of generating odometer data begins at a step 1013 in which an odometer arrangement obtains velocity information from a first rear wheel encoder at a particular time increment. That is, velocity data collected by an encoder on a first rear wheel of the vehicle is obtained at a particular time. In one embodiment, an overall encoder arrangement or system includes one encoder on each rear wheel of the vehicle, although it should be understood that an overall encoder arrangement may generally include any number of encoders. Further, the encoders of an overall encoder arrangement are not limited to being positioned on the rear wheels of a vehicle. The time increment at which information may be obtained may vary widely depending upon factors including, but not limited to including, a desired measurement accuracy and/or available computer resources. The time increment may be, for example, approximately one second. It should be appreciated, however, that the time increment is not limited to approximately one second.

In a step 1017, the odometer arrangement obtains velocity information from a second rear wheel encoder at a particular time increment. It should be appreciated that velocity information may be obtained from the first rear wheel encoder and the second rear wheel encoder at approximately the same time.

Once the velocity information is obtained from the first rear wheel encoder and from the second rear wheel encoder, the odometer arrangement determines an average velocity in a step 1021 using the first rear wheel encoder velocity and the second rear wheel encoder velocity. Using the velocity information, the odometer arrangement may derive or otherwise obtain a distance approximation, or odometer data, from the average velocity in a step 1025. A distance approximation, or an approximation of distance travelled by the vehicle, may be obtained using any suitable method. For example, approximating a distance may include, but is not limited to including, processing the average velocity and the time increment, as for example by integrating the average velocity or by performing a trapezoidal approximation on the average velocity. Upon obtaining the distance approximation, the method of generating odometer data is completed.

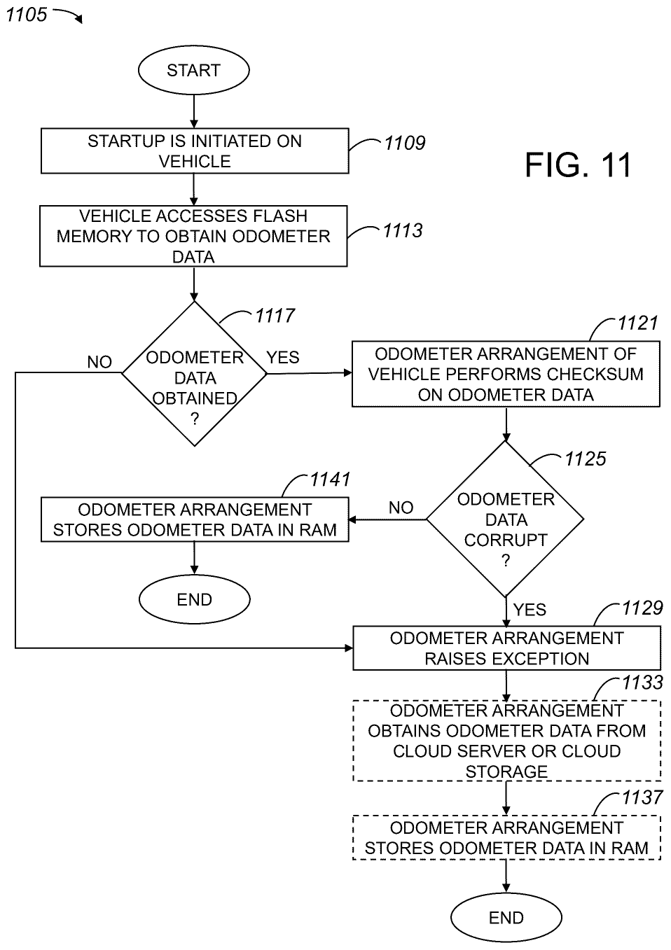

Odometer data that is stored, e.g., stored in a flash memory on a vehicle, may be accessed when the vehicle is turned on or started up. A main compute of the vehicle, or other suitable vehicle system on the vehicle, may obtain the stored odometer data as part of a startup process for the vehicle. FIG. 11 is a process flow diagram which illustrates a method of obtaining stored odometer data in accordance with an embodiment. A method of obtaining stored odometer data begins at a step 1109 in which startup is initiated on a vehicle. Initiating startup may generally include, but is not limited to including, providing power to the vehicle and initiating systems on the vehicle. For example, if the vehicle is an electric vehicle, providing power to the vehicle may include providing electricity to the vehicle from an onboard battery.

As part of the startup process on a vehicle, the vehicle may access flash memory to obtain odometer data in a step 1113. In general, an odometer arrangement on the vehicle may access the flash memory, or cause the flash memory to be accessed by another vehicle system, to read the odometer data.

A determination is made in a step 1117 as to whether the odometer data has been successfully obtained. If it is determined that the odometer data has been successfully obtained, process flow proceeds to a step 1121 in which the odometer arrangement performs a checksum on the odometer data. Performing a checksum enables a determination to be made as to whether the odometer data is corrupted.

In a step 1125, it is determined whether the odometer data is corrupt. If it is determined that the odometer data is not corrupt, then process flow proceeds to a step 1141 in which the odometer arrangement stores or writes the odometer data into RAM. Upon storing the odometer data into the RAM, the method of obtaining stored odometer data is completed.

Alternatively, if it is determined in step 1125 that the odometer data is corrupt, the odometer arrangement raises an exception in a step 1129 e.g., an exception which indicates that the odometer data has been obtained but is corrupt. Raising an exception may enable a vehicle operator or maintenance technician to be alerted to the existence of either a malfunctioning encoder arrangement or a malfunctioning flash memory. After the odometer arrangement raises the exception, process flow moves to an optional step 1133 in which the odometer arrangement obtains odometer data from a cloud server or cloud storage. Such obtained odometer data may optionally be stored in RAM in a step 1137 and the method of obtaining stored odometer data is completed.

Returning to step 1117, if it is determined that odometer data has not been obtained from the flash memory, the implication may be that the odometer data is missing or that the flash memory has an issue preventing the odometer data from being obtained. As such, process flow moves from step 1117 to step 1129 in which the odometer arrangement raises an exception, e.g., an exception which indicates that the odometer data is essentially unavailable.

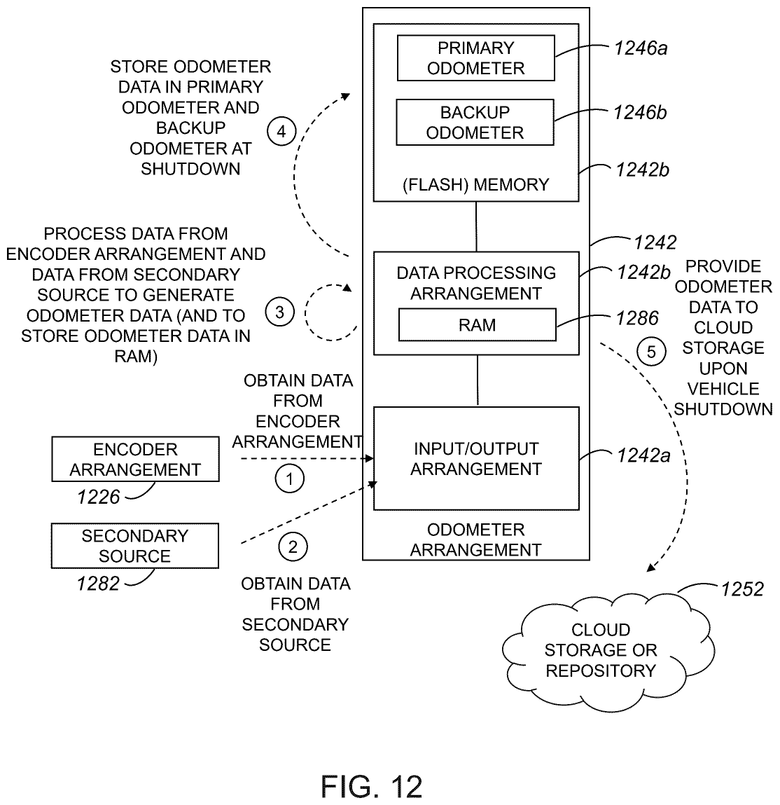

In one embodiment, to increase the likelihood that odometer data generated by an odometer arrangement is accurate, a secondary source may provide raw data that may be used in addition to data obtained from an encoder to drive the odometer data. FIG. 12 is a diagrammatic representation of a process of obtaining encoder data and storing odometer data that includes utilizing data from a secondary source in accordance with an embodiment. An encoder arrangement 1226, a secondary source 1282, and an odometer arrangement 1242 are included in a vehicle such as vehicle 301 of FIG. 3. At a time t1, an input/output arrangement 1242a of odometer arrangement 1242 obtains data from encoder arrangement 1226. The data may generally be raw data obtained from encoder arrangement 1242 that relates to a number of times a wheel of a vehicle has turned during a particular time period. As mentioned above, encoder arrangement 1126 may include more than one encoder and, as such, input/output arrangement may include raw data from one or more encoders.

At a time t2, which may be approximately the same as time t1, input/output arrangement 1242a obtains data from secondary source 1282. Secondary source 1282 may be any suitable source which may provide data associated with a vehicle that may be processed by odometer arrangement 1242. For example, secondary source 1282 may be a secondary encoder arrangement such as a resolver, an inertial measurement unit (IMU), and/or a magnetic encoder. Secondary source 1282 may also be a signal computed by sensor fusion techniques, e.g., a Kalman filter, which effectively combines inputs from sensors such as encoders and IMUs such that a relatively reliable signal may be computed. When secondary source 1282 is a secondary encoder arrangement, encoder arrangement 1226 may be considered to be a primary encoder arrangement while secondary source 1282 may be considered to be a backup encoder arrangement.

The data or information obtained from encoder arrangement 1226 and secondary source 1282 is processed by data processing arrangement 1242b of odometer arrangement 1242 to generate odometer data, and to store the generated odometer data into RAM 1286, at a time t3. It should be appreciated that while data processing arrangement 1242b may use data from both encoder arrangement 1226 and secondary source 1282 to derive odometer data, data processing arrangement 1242b may instead effectively use data from either encoder arrangement 1226 or secondary source 1282 in some situations. For example, if encoder arrangement 1226 is determined not to be functioning properly, odometer data may be derived using data from substantially only secondary source 1282.

As mentioned above, in some embodiments, odometer data may be stored in a memory such as memory 1242c of odometer arrangement 1242 when a vehicle is shutting down. While odometer data may be stored periodically in memory 1242c, in the described embodiment, odometer data may be stored in RAM 1286 as it is generated, and substantially only written to memory 1242c when the vehicle is shutting down in order to effectively extend the life of memory 1242c. In the described embodiment, at a time t4, the vehicle is preparing to shut down. As such, the odometer data is stored in primary odometer 1246a and backup odometer 1246b of a memory 1242c, as for example a flash memory included in odometer arrangement 1242. It should be appreciated that although memory 1242c is shown as being included in odometer arrangement 1242, memory 1242c may instead be external to odometer arrangement 1242 but accessible to odometer arrangement 1242. That is, memory 1242c may be included in odometer arrangement 1242 or may be a component of a vehicle that is effectively separate from, but in communication with, odometer arrangement 1242.

At a time t5, also while the vehicle is preparing to shut down, data processing arrangement 1242b causes odometer data to be stored in an external storage arrangement 1252, e.g., a cloud storage or repository. Data processing arrangement 1242b may communicate with external storage arrangement 1252 using input/output arrangement 1242a. It should be appreciated that communications between input/output arrangement 1242a and external storage arrangement 1252 may utilize a communications system of the vehicle, as for example communications system 340 of vehicle 301 of FIG. 3, to support communications involving input/output arrangement 1242a.

Although only a few embodiments have been described in this disclosure, it should be understood that the disclosure may be embodied in many other specific forms without departing from the spirit or the scope of the present disclosure. By way of example, while an odometer arrangement has been described as including one data processing arrangement, an odometer may instead include more than one data processing arrangement. In one embodiment, an odometer arrangement may include a primary odometer and a backup odometer, and the primary odometer may include a primary data processing arrangement and the backup odometer may include a backup data processing arrangement.

While an odometer arrangement has been described as including a primary odometer and a secondary odometer, the number of odometers included in an odometer arrangement may vary widely. In other words, the number of odometers included in an odometer arrangement is not limited to approximately two odometers. Similarly, the number of external storage arrangements which may store odometer data or information off of the vehicle, e.g., in a repository or in cloud storage, may also vary widely.

In one embodiment, an overall odometer arrangement may include hardware and/or software logic that includes a primary odometer arrangement and a redundant odometer arrangement. For instance, an overall odometer arrangement may include a primary odometer arrangement and a redundant odometer arrangement that operate on substantially separate microprocessors while storing data in separate RAM and flash memories. That is, each odometer arrangement may have a separate microcontroller, RAM, and flash memory.

As mentioned above, odometer data that is stored remotely from a vehicle may be subject to security measures or procedures to essentially ensure that the odometer data is not tampered with. Security measures used to substantially ensure the security of the odometer data include, but are not limited to including, encryption and blockchain techniques. As will be understood by those skilled in the art, recording information such as odometer data using blockchain protects the information from being changed or otherwise manipulated. A blockchain is a decentralized, distributed, public ledger that duplicates and delivers transactions on a network of computing systems. A transaction recorded as a block in a blockchain may not be altered without altering subsequent blocks.

Various security features may be provided to substantially ensure that an odometer arrangement and, hence, an odometer may not be tampered with. For instance, a security key exchange may be implemented such that an odometer may not be updated absent a successful exchange of security keys.

While odometer data has generally described as being stored, as for example on a flash memory of a vehicle or externally with respect to the vehicle on a cloud server and/or in cloud storage, it should be appreciated that data which enables an odometer distance to be calculated may be stored in lieu of, or in addition to, the odometer distance itself. For instance, data from one or more encoders on a vehicle, in addition to time information that pertains to the data from the one or more encoders, may be stored such that an odometer distance may effectively be derived from the stored data as needed, e.g., a calculation of an odometer distance may be made from stored data when a vehicle powers on.

In addition to storing odometer data in a flash memory of a vehicle, and substantially backing up the odometer data by storing the odometer data on an external cloud server or in cloud storage, the odometer data may also be stored in a redundant storage element such as a redundant flash memory. Storing odometer data in a redundant storage element may facilitate the recovery of odometer data, as for example when a primary storage element such as a flash memory is not available due to a fault or corrupted data. In other words, backup power provided to the odometer device allows odometer to be saved as the vehicle is losing power, as a loss of power to the vehicle may appear to the odometer device to be substantially the same as a vehicle shutdown process.

Storing odometer data in the cloud on a cloud server may generally involve data stored on a vehicle, as for example in flash memory or any suitable hard drive on the vehicle, to be uploaded upon a shut down of the vehicle or the end of a vehicle mission. Such an upload process may be performed in a wireless manner. It should be appreciated that in some situations, odometer data may be stored in a memory associated with a main compute, and may be streamed substantially directly from the main compute to a cloud server in a wireless manner.

Hardware faults may occur with respect to hardware included in an encoder arrangement, an odometer arrangement, and/or flash memory. Providing redundant hardware may effectively mitigate the effects of hardware faults. When a hardware fault is detected, an exception may be raised to flag the hardware fault to a vehicle operator or maintenance technician. Hardware faults may be detected when there is a loss of communication, when there is an infeasible velocity jump identified by an encoder arrangement, when there are delayed communications or excessive latency, when messages are corrupt, etc.

In one embodiment, an odometer arrangement may include a substantially dedicated power source that is separate from an overall power source used to power a vehicle. For example, an odometer arrangement may include a battery that is arranged to provide power to the odometer arrangement in the event of a power loss or power failure associated with a vehicle. The dedicated power source may enable the odometer arrangement to operate to store odometer data to a flash memory and/or cloud storage in the event that the vehicle suffers a power loss or power failure.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner. Further, it should be understood that while an autonomous vehicle may be an occupant-less or passenger-less vehicle as shown in FIGS. 1 and 2, an autonomous vehicle may also be a vehicle that carries occupants or passengers. In other words, an autonomous vehicle is not limited to transporting cargo or goods, and may also transport occupants or passengers.

While replacing an odometer arrangement or, more generally, when replacing a controller board such as a BSC board that includes the odometer arrangement, odometer data or readings may be retrieved from a cloud server or cloud storage substantially automatically. It should be appreciated that in lieu of an odometer data being substantially automatically retrieved from a cloud server or cloud storage and effectively uploaded to a new BSC board, a process of providing odometer data to a new BSC board may instead be a manual process. For example, a vehicle technician may obtain odometer data for a particular vehicle from a cloud server or cloud storage when the vehicle technician is providing or installing a new BSC board in the vehicle, and may program the obtained odometer data into the new BSC board.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the arrangements or systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein, but may be modified within the scope of the appended claims.

What is claimed is:

1. A method comprising:
obtaining sensor data from at least one sensor, the at least one sensor being positioned on a vehicle, wherein the vehicle includes an odometer arrangement and a memory;
processing the sensor data using the odometer arrangement, wherein processing the sensor data includes deriving odometer data from the sensor data, the odometer data being arranged to indicate a first distance travelled by the vehicle;
storing the odometer data in a memory of the vehicle; and
providing the odometer data to an external storage.

2. The method of claim 1 wherein the at least one sensor includes at least one encoder and the memory is a flash memory, the method further including:
determining when the vehicle is shutting down, wherein the odometer data is stored in the flash memory of the vehicle when it is determined that the vehicle is shutting down.

3. The method of claim 2 wherein the external storage is one selected from a group including a cloud server and a cloud storage, and wherein the odometer data is provided to the external storage when it is determined that the vehicle is shutting down.

4. The method of claim 2 wherein processing the sensor data using the odometer arrangement includes storing the odometer data in a random access memory (RAM) of the vehicle.

5. The method of claim 1 further including:
after storing the odometer data in the memory, determining when the vehicle is powering on;
obtaining the odometer data from the memory when it is determined that the vehicle is powering on; and
storing the odometer data obtained from the memory in a random access memory (RAM) of the vehicle after obtaining the odometer data from the memory.

6. The method of claim 5 further including:
determining when the odometer data obtained from the memory is corrupt;
obtaining the odometer data from the external storage when it is determined that the odometer data obtained from the memory is corrupt; and
storing the odometer data obtained from the external storage in the RAM of the vehicle after obtaining the odometer data from the external storage.

7. The method of claim 1 wherein the at least one sensor includes at least one encoder encoder, and wherein the at least one encoder includes a first encoder and a second encoder, and obtaining the encoder data from the at least one encoder includes obtaining first encoder data from the first encoder and obtaining second encoder data from the second encoder, wherein deriving the odometer data from the encoder data includes determining an average velocity from the first encoder data and the second encoder data.

8. Logic encoded in one or more tangible non-transitory, computer-readable media for execution and when executed operable to:
obtain sensor data from at least one sensor, the at least one sensor being positioned on a vehicle, wherein the vehicle includes an odometer arrangement and a memory;
process the sensor data using the odometer arrangement, wherein the logic operable to process the sensor data is operable to derive odometer data from the sensor data, the odometer data being arranged to indicate a first distance travelled by the vehicle;
store the odometer data in a memory of the vehicle; and
provide the odometer data to an external storage.

9. The logic of claim 8 wherein the at least one sensor includes at least one encoder and the memory is a flash memory, the logic further being operable to:
determine when the vehicle is shutting down, wherein the odometer data is stored in the flash memory of the vehicle when it is determined that the vehicle is shutting down.

10. The logic of claim 9 wherein the external storage is one selected from a group including a cloud server and a cloud storage, and wherein the odometer data is provided to the external storage when it is determined that the vehicle is shutting down.

11. The logic of claim 9 wherein the logic operable to process the sensor data using the odometer arrangement is operable to store the odometer data in a random access memory (RAM) of the vehicle.

12. The logic of claim 8 wherein the logic is further operable to:
determine when the vehicle is powering on after the odometer data is stored in the memory;
obtain the odometer data from the memory when it is determined that the vehicle is powering on; and
store the odometer data obtained from the memory in a random access memory (RAM) of the vehicle after the odometer data is obtained from the memory.

13. The logic of claim 12 wherein the logic is further operable to:
determine when the odometer data obtained from the memory is corrupt;
obtain the odometer data from the external storage when it is determined that the odometer data obtained from the memory is corrupt; and
store the odometer data obtained from the external storage in the RAM of the vehicle after the odometer data is obtained from the external storage.

14. The logic of claim 8 wherein the at least one sensor includes at least one encoder, and wherein the at least one encoder includes a first encoder and a second encoder, and the logic operable to obtain the encoder data from the at least one encoder includes logic operable to obtain first encoder data from the first encoder and obtaining second encoder data from the second encoder, wherein the logic operable to derive the odometer data from the encoder data includes logic operable to determine an average velocity from the first encoder data and the second encoder data.

15. A vehicle comprising:
a chassis;
a memory carried on the chassis;
at least one wheel coupled to the chassis, the at least one wheel having at least one sensor positioned thereon;
one or more tangible non-transitory, computer-readable media carried on the chassis; and
logic encoded in the one or more tangible non-transitory, computer-readable media for execution and when executed operable to:
obtain sensor data from the at least one sensor,
process the sensor data, wherein the logic operable to process the sensor data is operable to derive odometer data from the sensor data, the odometer data being arranged to indicate a first distance travelled by the vehicle,
store the odometer data in the memory, and
provide the odometer data to an external storage.

16. The vehicle of claim 15 wherein the at least one sensor includes at least one encoder, and wherein the memory is a flash memory and the logic is further operable to:
determine when the vehicle is shutting down, wherein the odometer data is stored in the flash memory of the vehicle when it is determined that the vehicle is shutting down.

17. The vehicle of claim 16 wherein the external storage is one selected from a group including a cloud server and a cloud storage, and wherein the odometer data is provided to the external storage when it is determined that the vehicle is shutting down.

18. The vehicle of claim 16 wherein the logic operable to process the sensor data using the odometer arrangement is operable to store the odometer data in a random access memory (RAM) of the vehicle.

19. The vehicle of claim 15 wherein the logic is further operable to:
determine when the vehicle is powering on after the odometer data is stored in the memory;
obtain the odometer data from the memory when it is determined that the vehicle is powering on; and
store the odometer data obtained from the memory in a random access memory (RAM) of the vehicle after the odometer data is obtained from the memory.

20. The vehicle of claim 15 wherein the one or more tangible non-transitory, computer-readable media carried on the chassis is a brain stem controller (BSC).
